(19) United States
(12) Patent Application Publication
(10) Pub. No.: US 2019/0197496 A1
(43) Pub. Date: Jun. 27, 2019

(54) TASK REMINDING METHOD AND APPARATUS FOR MULTIPLE INFORMATION SOURCES

(71) Applicant: Alibaba Group Holding Limited, Grand Cayman (KY)

(72) Inventors: Boyu Yang, Zhejiang (CN); Ming Zhang, Zhejiang (CN); Hang Chen, Zhejiang (CN)

(21) Appl. No.: 16/287,940

(22) Filed: Feb. 27, 2019

Related U.S. Application Data
(63) Continuation of application No. PCT/CN2017/097652, filed on Aug. 16, 2017.

(30) Foreign Application Priority Data
Aug. 29, 2016 (CN) 201610751405.8

(51) Int. Cl. G06Q 10/10; G06F 9/44; H04L 12/58

(52) U.S. Cl. CPC G06Q 10/1097; H04L 51/046; G06F 9/44

(57) ABSTRACT

Task reminding methods and apparatuses for multiple information sources are provided. The method may include determining concerned processing function(s) related to a user from among processing functions that are supported by an instant messaging application; obtaining task message(s) corresponding to the at least one concerned processing function; and displaying the obtained task message(s) in a centralized manner. Through the technical solutions of the present disclosure, all task messages of concerned processing functions can be collectively displayed without requiring the user to perform separate viewing for each processing function, which helps to improve the efficiency of task processing. At the same time, a reminding operation can also be actively initiated to the user through intelligent semantic recognition of a task message, thereby ensuring that the task message is processed in time.

### CROSS REFERENCE TO RELATED PATENT APPLICATIONS

This application claims priority to and is a continuation of PCT Patent Application No. PCT/CN2017/097652 filed on 16 Aug. 2017, and is related to and claims priority to Chinese Patent Application No. 201610751405.8, filed on 29 Aug. 2016, entitled “Task Reminding Method and Apparatus for Multiple Information Sources,” which are hereby incorporated by reference in their entirety.

### TECHNICAL FIELD

The present disclosure relates to the technical field of communications, and particularly to reminding methods and apparatuses for multiple information sources.

### BACKGROUND

In related technologies, an instant messaging application can support a variety of processing functions, which are not only limited to instant messaging functions, but may also include other types of communication functions, such as mail, and group management functions, such as approval, attendance, etc., so that a user does not need to separately install related applications and repeatedly perform switching between multiple applications.

Since the processing functions are still relatively independent, the user needs to enter a function page corresponding to each processing function in order to view and process a task message generated by the corresponding processing function. As such, the user needs to repeatedly switch between function pages corresponding to various processing functions, resulting in very complex and inefficient processes of viewing and processing task messages.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

In view of the above, the present disclosure provides task reminding methods and apparatuses for multiple information sources, which can display task messages of all processing functions that are followed in a centralized manner without requiring a user to separately query and view each processing function, thereby facilitating the efficiency of task processing.

To achieve the above objectives, the present disclosure provides the following technical solutions.

In implementations, a task reminding method for multiple information sources is provided, which includes determining concerned processing function(s) related to a user from among processing functions that are supported by an instant messaging application; obtaining task message(s) corresponding to the at least one concerned processing function; and displaying the obtained task message(s) in a centralized manner.

In implementations, a task reminding method for multiple information sources is provided, which includes displaying a calendar page corresponding to a calendar management function when an instant messaging application includes the calendar management function, the calendar page including a first area and a second area; displaying task message(s) corresponding to at least one concerned processing function in the first area according to concerned processing function(s) related to a user among processing functions that are supported by the instant messaging application; displaying calendar information in the second area; and when any date or date interval in the calendar information is selected, displaying a task message matching the selected date or date interval in the first area.

In implementations, a task reminding apparatus for multiple information sources is provided, which includes a function determination unit that determines concerned processing function(s) related to a user from among processing functions that are supported by an instant messaging application; an acquisition unit that obtains task message(s) corresponding to the at least one concerned processing function; and a display unit that displays the obtained task message(s) in a centralized manner.

In implementations, a task reminding apparatus for multiple information sources is provided, which includes a page display unit that displays a calendar page corresponding to a calendar management function when an instant messaging application includes the calendar management function, the calendar page including a first area and a second area; a display unit that displays task message(s) corresponding to at least one concerned processing function in the first area according to concerned processing function(s) related to a user among processing functions that are supported by the instant messaging application, and displays calendar information in the second area; and a message presentation unit that, when any date or date interval in the calendar information is selected, displays a task message matching the selected date or date interval in the first area.

As can be seen from the above technical solutions, the present disclosure can enable a user to personally select processing function(s) according to actual needs, and personally customize information source channel(s) that is/are concerned by the user, i.e., concerned processing function(s) corresponding to task messages. At the same time, the present disclosure obtains and centrally displays the task messages of the concerned processing function(s), so that the user can view and manage all the task messages of the concerned processing functions without repeatedly switching between function pages of multiple processing functions, thus helping to improve the efficiency of task management in an instant messaging application.

### BRIEF DESCRIPTION OF THE DRAWINGS

FIG. 1 is a flowchart of a task reminding method for multiple information sources according to an exemplary embodiment of the present disclosure.

FIG. 2 is a flowchart of another task reminding method for multiple information sources provided by an exemplary embodiment of the present disclosure.

FIG. 3 is a schematic diagram of an interface for reminding tasks of multiple information sources according to an exemplary embodiment of the present disclosure.

FIG. 4 is a schematic diagram of another interface for reminding tasks of multiple information sources according to an exemplary embodiment of the present disclosure.

FIG. 5 is a schematic diagram of another interface for reminding tasks of multiple information sources according to an exemplary embodiment of the present disclosure.

FIG. 6 is a schematic diagram of another interface for reminding tasks of multiple information sources according to an exemplary embodiment of the present disclosure.

FIG. 7 is a schematic diagram of another interface for reminding tasks of multiple information sources according to an exemplary embodiment of the present disclosure.

FIG. 8 is a schematic diagram of another interface for reminding tasks of multiple information sources according to an exemplary embodiment of the present disclosure.

FIG. 9 is a schematic diagram of another interface for reminding tasks of multiple information sources according to an exemplary embodiment of the present disclosure.

FIG. 10 is a schematic diagram of another interface for reminding tasks of multiple information sources according to an exemplary embodiment of the present disclosure.

FIG. 11 is a schematic diagram of another interface for reminding tasks of multiple information sources according to an exemplary embodiment of the present disclosure.

FIG. 12 is a schematic diagram of another interface for reminding tasks of multiple information sources according to an exemplary embodiment of the present disclosure.

FIG. 13 is a flowchart of another task reminding method for multiple information sources according to an exemplary embodiment of the present disclosure.

FIG. 14 is a schematic structural diagram of an electronic device according to an exemplary embodiment of the present disclosure.

FIG. 15 is a block diagram of an apparatus for multiple information sources according to an exemplary embodiment of the present disclosure.

FIG. 16 is a schematic structural diagram of another electronic device according to an exemplary embodiment of the present disclosure.

FIG. 17 is a block diagram of another apparatus for multiple information sources according to an exemplary embodiment of the present disclosure.

FIG. 18 is a schematic structural diagram of an example apparatus as described in FIGS. 15 and 17 in further detail.

### DETAILED DESCRIPTION

In related technologies, a user needs to manually and individually create task messages of interest. However, as the number of task messages is large, the user has to consume a lot of time and effort. Furthermore, the user finds it difficult to maintain for a long-term, and often completely gives up this way of manual processing very quickly.

Therefore, the present disclosure can solve the above problems in the related technologies by proposing schemes of reminding tasks of multiple information sources. In order to further illustrate the present disclosure, the following embodiments are provided.

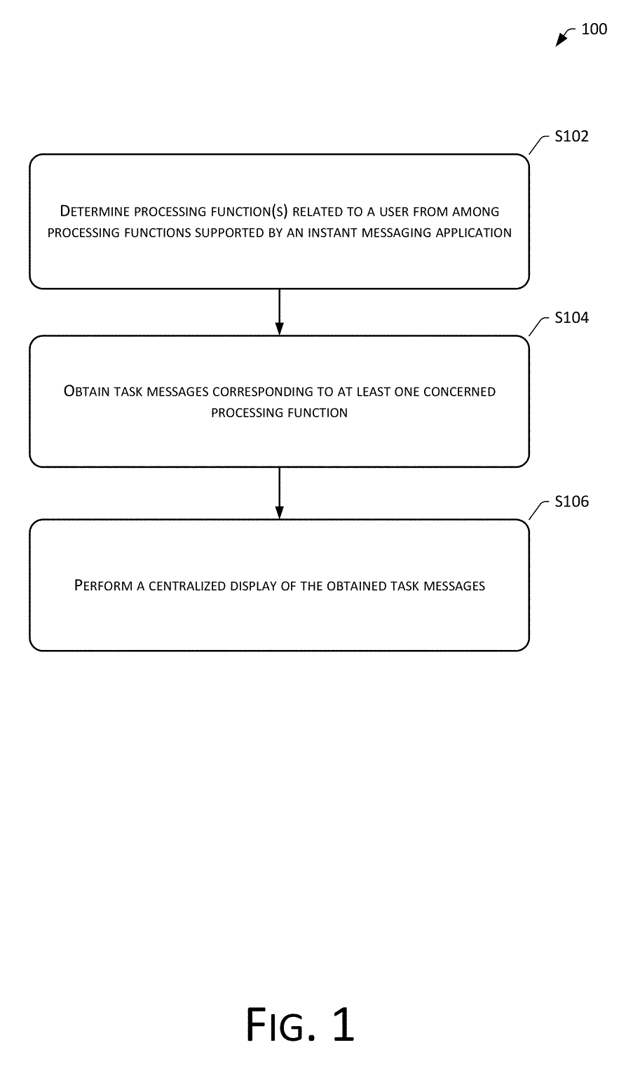

FIG. 1 is a flowchart of a task reminding method 100 for multiple information sources according to an exemplary embodiment of the present disclosure. As shown in FIG. 1, the method 100 is applied in an electronic device, and may include the following operations.

S102: Determine processing function(s) related to a user from among processing functions supported by an instant messaging application.

In implementations, an instant messaging application can support multiple processing functions, which include a variety of communication functions such as an instant messaging function, a mail function, and a variety of group management functions such as approval, attendance, or any other functions supported by the instant messaging application.

In implementations, any instant messaging application that supports multiple processing functions can be applied in the technical solutions of the present disclosure, which is not limited in the present disclosure. For example, the instant messaging application can be an enterprise instant messaging (EIM) application, such as “DING Talk”, etc.

In implementations, the user may select a number of processing functions that are of interest from among a plurality of processing functions that are supported by the instant messaging application according to actual needs, i.e., concerned processing functions, thereby completing a manual configuration of the concerned processing function. Alternatively, after a server (for example, a “DING Talk” server corresponding to a “DING Talk” client) intelligently analyzes processing functions related to the user and messages in the processing functions, the server actively analyzes and determines the concerned processing functions that are related to the user. Adding attention to the processing functions is equivalent to increasing an execution dimension of an attention operation from a task message dimension to a processing function dimension, which is equivalent to all task messages corresponding to the concerned processing functions being followed without requiring the user to manually enter corresponding processing pages and manual following the task messages individually, thus greatly improving the efficiency of management of the task messages.

S104: Obtain task messages corresponding to at least one concerned processing function.

S106: Perform a centralized display of the obtained task messages.

In implementations, when the instant messaging application includes (e.g., cooperatively supports) a calendar management function, the obtained task messages may be collectively displayed in a first area of a calendar page corresponding to the calendar management function, where calendar information is shown in a second area of the calendar page that is different from the first area. By displaying the calendar information and the task messages simultaneously in different areas of the calendar page, the user can view the calendar information with the task messages in conjunction, which helps query and control the processing deadlines of the task messages.

In implementations, task message(s) matching the calendar information may be selected from the obtained task messages for presentation in the first area. For example, when the calendar information shows the current month, only task message(s) matching that month may be displayed in the first area, for example, a task message which processing deadline is located in the month. Alternatively, when the calendar information shows the current week, only task message(s) matching that week may be displayed in the first area, thereby further associating the calendar information with the task messages. As such, the user can perform an effective management of the task messages based on the calendar information.

In implementations, a selected date or date interval in the calendar information may also be determined according to a user selection instruction that is received, so that task message(s) matching the selected date or date interval is/are displayed in the first area. As such, the user can set a date or date interval according to actual needs, and view and manage task message(s) corresponding to the set date or date interval. When a processing deadline of a task message is the selected date or belongs to the selected date interval, a determination can be made that the task message matches the selected date or date interval.

In implementations, when any date in the calendar information includes a matching task message, a preset prompt identifier may be displayed on that date, so that the user can roughly understand distribution and deadline statuses of task messages when viewing the calendar information, which helps the user to quickly control task processing statuses.

In implementations, according to a triggering operation that is received for any task message, switching to a processing page of that task message may be made to facilitate the user to view that task message in detail and perform specific processing thereon.

In implementations, a respective processing deadline of each task message may also be obtained. A task reminding request corresponding to each task message is initiated to a server according to the respective processing deadline, so that the server may initiate a task reminding event at a corresponding reminding time point before the respective processing deadline, thus implementing a task reminder to the user. For example, when DING Talk is used to implement the technical solutions of the present disclosure, the DING Talk may send a reminding message in a form of an instant messaging message, a short message or a telephone voice message to the user as the foregoing task reminding event. Therefore, when an electronic device responds to the task reminding event initiated by the server, a task reminder for the user is implemented accordingly.

As can be seen from the above technical solutions, the present disclosure can enable a user to personally select processing function(s) according to actual needs, and personally customize information source channel(s) that is/are concerned by the user, i.e., concerned processing function(s) corresponding to task messages. At the same time, the present disclosure obtains and collectively displays the task messages of the concerned processing function(s), so that the user can view and manage all the task messages of the concerned processing functions without repeatedly switching between function pages of multiple processing functions, thus helping to improve the efficiency of task management in an instant messaging application.

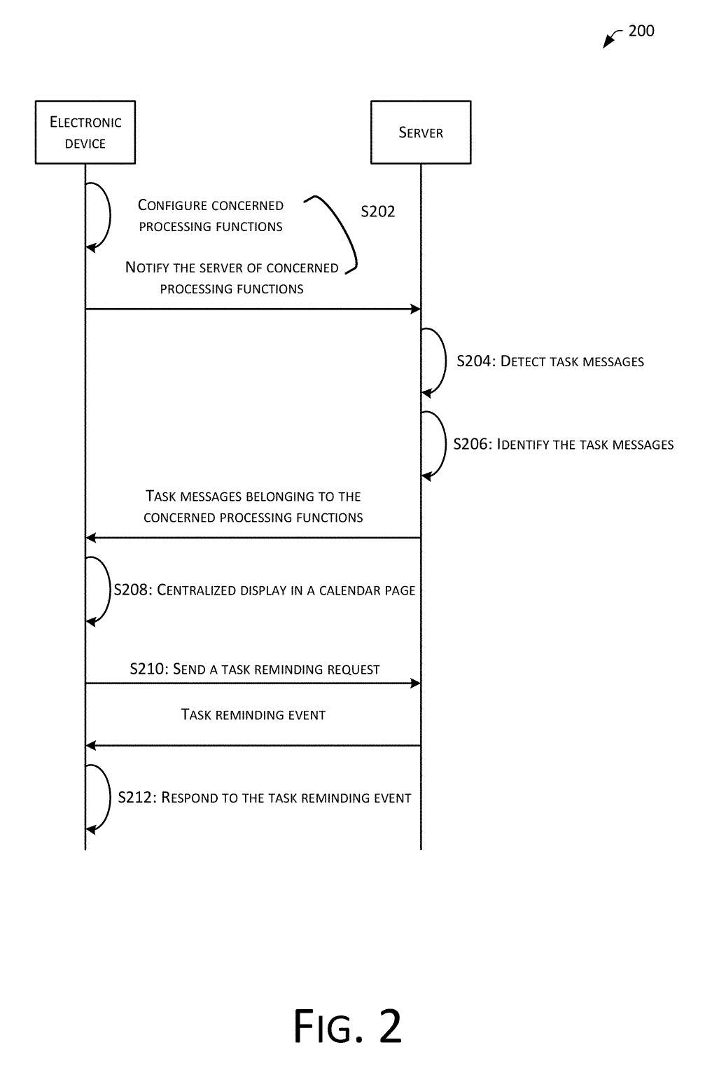

For the sake of understanding, an example of a handling process of an enterprise instant messaging application (DING Talk) in an enterprise scenario is used in conjunction with FIG. 2 to describe the technical solutions of the present disclosure in detail. FIG. 2 is a flow chart of another task reminding method 200 for multiple information sources provided by an exemplary embodiment of the present disclosure. As shown in FIG. 2, the method 200 is applied in an electronic device on which a DING Talk client is installed and a DING Talk server, and combines data interactions between the DING Talk client and the DING Talk server to implement a task reminding function of multiple information sources of the present disclosure. The method may include the following operations.

S202: An electronic device configures concerned processing functions and notifies a server of the concerned processing functions.

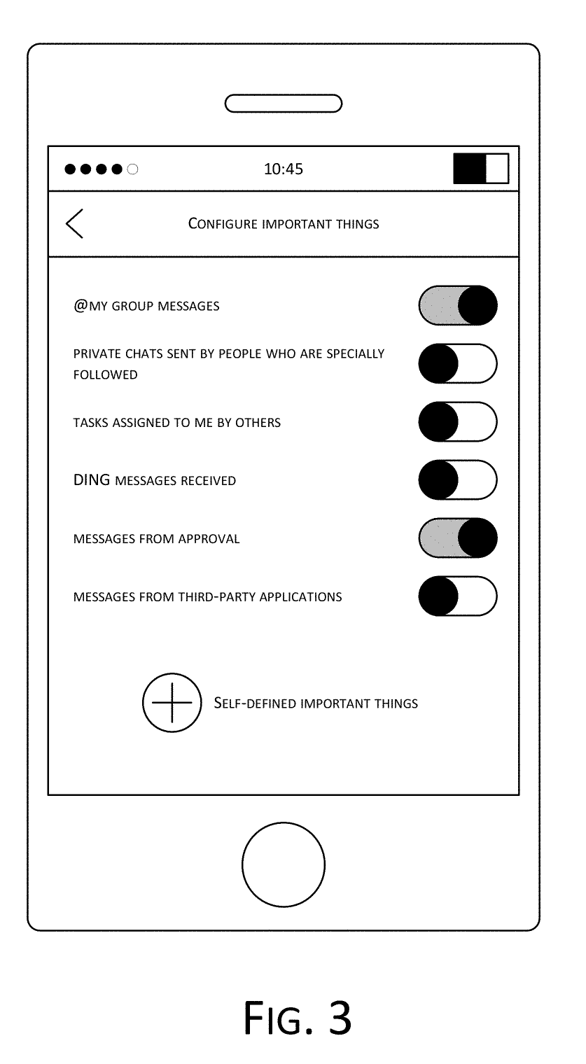

In implementations, DING Talk can provide a configuration page as shown in FIG. 3 for a user to configure concerned processing function(s), i.e., “important things” in FIG. 3. As shown in FIG. 3, predefined processing functions can be provided in the configuration page, for example, “@my group messages”, “private chats sent by people who are specially followed”, etc. that belong to “instant messaging functions”, “messages from approval” that belongs to “approval functions”, and “tasks assigned to me by others”, “DING messages received”, “messages from third-party applications”, etc. that belong to other processing functions. A user can move a button corresponding to each processing function to the right, to set the corresponding processing function as a concerned processing function, such as “@my group messages”, “messages from approval”, etc. in FIG. 3.

In implementations, in addition to the above-mentioned processing functions that are provided by default in DING Talk, a user can also customize processing functions. For example, FIG. 3 provides a function of “self-define important things”. In response to detecting that a “⊕” identifier is triggered, a corresponding processing function can be created according to a user operation.

Furthermore, other than having a user manually configuring concerned processing functions, a DING Talk server can actively determine concerned processing function(s) that is/are related to the user after intelligently analyzing processing functions, message types and message content in the processing functions, and behavior and habits of the user, etc. This thereby helps simplify user operations without requiring manual configuration of the user.

S204: A server detects task message(s).

S206: The server identifies the task message(s), and the process proceeds to S208 when the task message(s) belong(s) to concerned processing function(s), otherwise the process returns to S204.

In implementations, the DING Talk server may detect and examine any task message, and distinguish task messages according to whether the task messages come from the concerned processing functions that are configured by the user, so that a DING Talk client can display task messages corresponding to the concerned processing functions in a centralized manner. By actively detecting and collectively displaying all the task messages of the concerned processing functions, the user does not need to manually enter a function page corresponding to each of the processing functions, and the user does not need to repeatedly switch between multiple function pages manually. As such, centralized viewing and management of related task messages is implemented, which helps improve the efficiency of processing the task messages.

Apparently, in other embodiments, the task messages may be actively detected and distinctively displayed by the DING Talk client, which is not limited in the present disclosure.

S208: The electronic device displays task message(s) belonging to the concerned processing function(s) on a calendar page in a centralized manner.

In implementations, when an instant messaging application cooperatively supports a calendar management function, obtained task messages can be collectively displayed in a first area of a calendar page corresponding to the calendar management function, where calendar information is shown in a second area of the calendar page that is different from the first area.

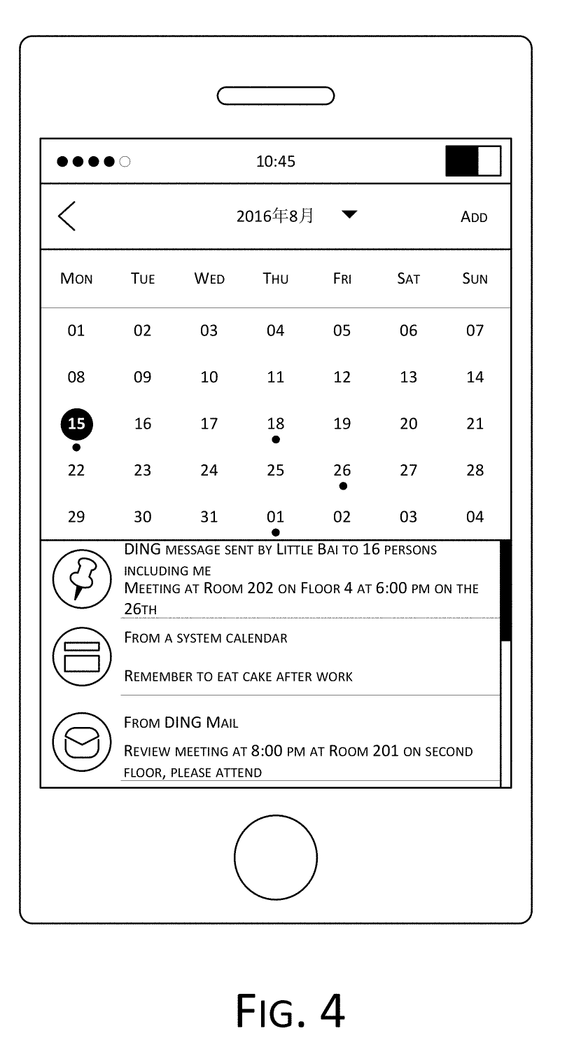

For example, a calendar page as shown in FIG. 4 includes a first area that is located in the lower half of the page and a second area that is located in the upper part of the page. By collectively displaying all task messages corresponding to concerned processing functions that are obtained in the first area and displaying calendar information in the second area, this facilitates performing a comparative view of respective processing deadlines of the task messages and the calendar information, and managing the task messages based on the calendar information in a convenient manner.

FIG. 4 exemplarily lists three task messages. The first task message is “a DING message sent by Little Bai to 16 persons including me”, which corresponds to the “DING messages received” in FIG. 3. The second task message comes “from a system calendar”, and the third task message comes “from DING mail”. Processing functions corresponding to the two task messages are all defined by the user through the “self-define important things” in FIG. 3. According to an analysis of message content of the three task messages, a task deadline of the first task message is “Aug. 26, 2016”, task deadlines of the second task message and the third task message are “Today”, i.e., “Aug. 15, 2016”. Therefore, it can be considered that matching task messages for these two dates “Aug. 26, 2016” and “Aug. 15, 2016” exist in the calendar information displayed in the second area of FIG. 4. Preset prompt identifiers can be displayed on these two dates. For example, these prompt identifiers may be dots “⊚” that are displayed under “15” and “26” in FIG. 4. Although the size of the first area is limited and the user needs to turn a page in the first area in order to view other task messages, it is still possible to determine that matching task messages exist on corresponding dates “Aug. 18, 2016” and “Sep. 1, 2016” even if a page turning operation is not performed, because above-mentioned prompt identifiers are also displayed below “18” and “01” in the calendar information. This thereby facilitates a user to quickly and easily view and manage task messages in conjunction with the calendar information.

As shown in FIG. 4, multiple task messages from the concerned processing function(s) may exist, and these task messages may be arranged in a certain order to facilitate viewing and processing by the user. In an embodiment, an arrangement may be made according to a time sequence of generation of the task messages, such as displaying a task message that is generated at a later time at a higher position. In another embodiment, an arrangement may be made according to processing deadlines of the task messages, such as displaying a task message with a sooner processing deadline at a higher position. In still another embodiment, an arrangement may be made according to priorities of the task messages. For example, the user may further perform importance level configuration for each concerned processing function in advance (an importance level of a task message is consistent with an importance level of a corresponding concerned processing function). Alternatively, the DING Talk server actively analyzes an importance level of each task message intelligently, so that the more important task message is displayed at a higher position. Apparently, an arrangement of messages can be performed in other ways, which are not exhaustively described herein.

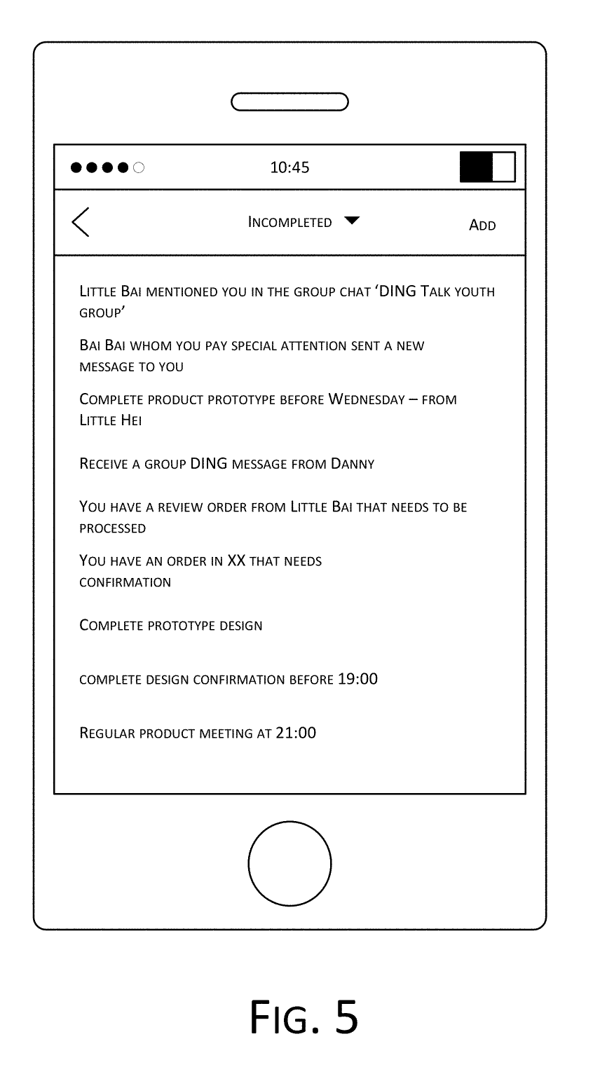

Apparently, a task message corresponding to a concerned processing function may not necessarily be combined with the calendar information for display. For example, a detected task message corresponding to a concerned processing function can be separately displayed as shown in FIG. 5. For example, “Little Bai mentioned you in the group chat ‘DING Talk youth group’” in FIG. 5 corresponds to a concerned processing function “@my group messages”, “Bai Bai whom you pay special attention sent a new message to you” corresponds to a concerned processing function “private chats from persons to whom special attention is paid”, and “Complete product prototype before Wednesday—from Little Hei” corresponds to a concerned processing function “task assigned by others”, etc., which will not exhaustively listed herein.

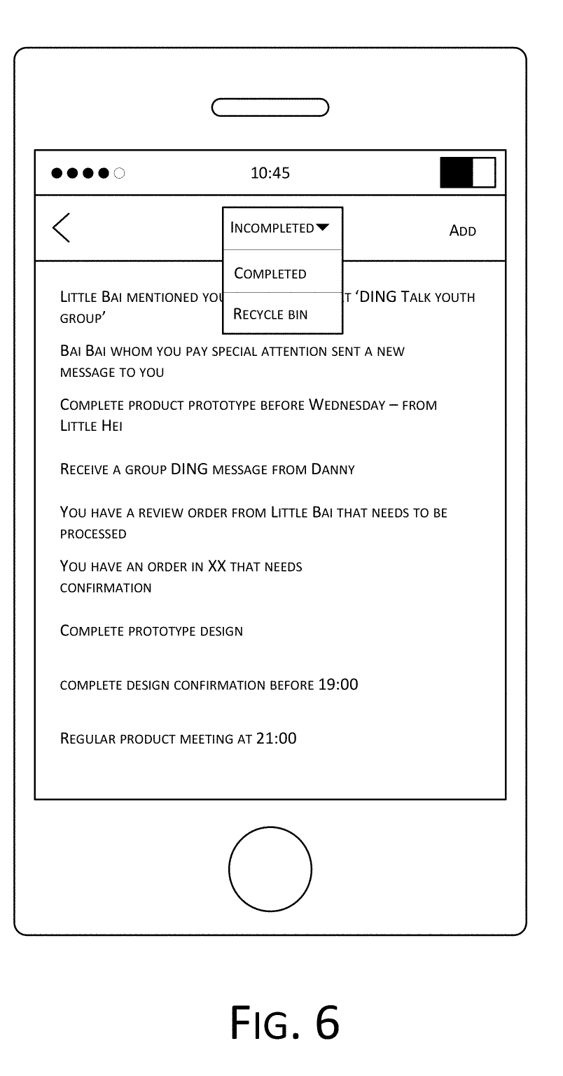

In the technical solutions of the present disclosure, task messages in different processing stages can also be classified and displayed. For example, FIG. 5 shows task messages in an “incompleted” phase, and task messages that are not specifically described in the present disclosure belong to such type of task messages. Furthermore, FIG. 6 shows other types such as “completed” and “recycle bin”, which correspond to completed and deleted task messages. These task messages usually are not displayed by default, but can be called out as historical messages by the user for viewing.

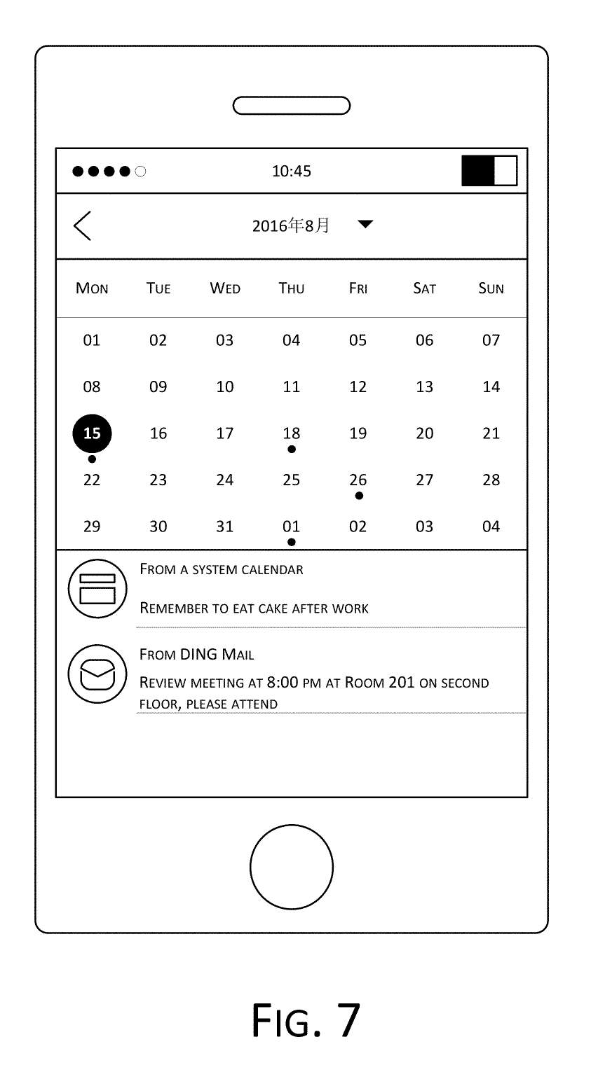

To facilitate understanding and description, an embodiment in which task messages and calendar information are displayed in association with each other as shown in FIG. 4 is used for description. In implementations, all task messages can be displayed in a first area, so that a user can perform browsing by turning pages. Since processing deadlines of the task messages may have a large time difference (for example, the earliest and latest processing deadlines may be different by several months or more), task message(s) matching the calendar information may be selected from obtained task messages for presentation in the first area in order to enhance an association between the task messages and the calendar information. For example, as shown in FIG. 4, when the calendar information is “August 2016”, task messages having processing deadlines belonging to “August 2016” can be selected, and only these task messages are displayed in the first area, while other task messages are hidden. Similarly, as shown in FIG. 7, task messages can be specified to “Today”, i.e., “Aug. 15, 2016” as shown in FIG. 7. As such, only task messages having processing deadlines as “Aug. 15, 2016” are displayed in the first area, thus allowing the user to quickly understand all important events of the current day (that is, all task messages corresponding to concerned processing functions) through a calendar page as shown in FIG. 7, which greatly enhances the task processing efficiency of user.

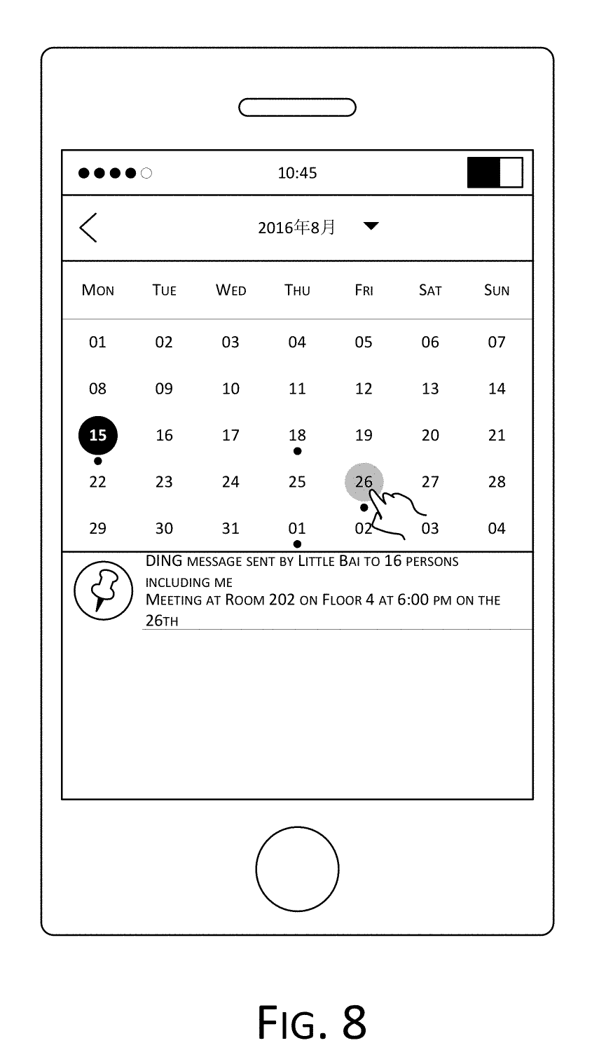

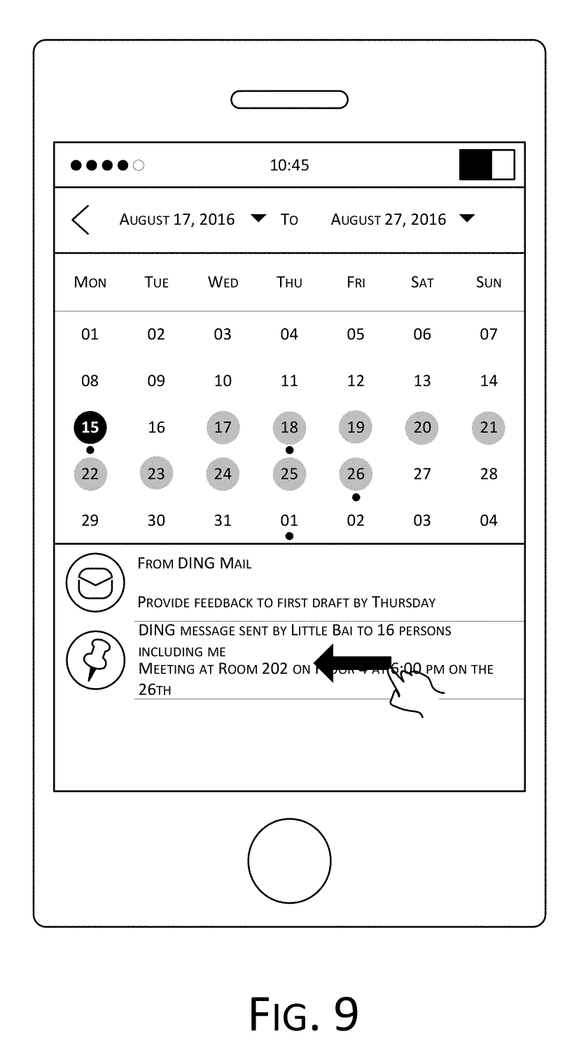

In implementations, a selected date or date interval in the calendar information may also be determined according to a user selection instruction that is received, and task message(s) matching the selected date or date interval is/are displayed in the first area. In other words, the user can select a date or date interval of interest according to his/her actual needs, to separately view task messages which processing deadlines fall within the date or date interval. For example, as shown in FIG. 8, when the user selects “26”, that is, “Aug. 26, 2016”, only task messages which processing deadlines are “Aug. 26, 2016” may be shown. When the user selects “17” and “26”, that is, a date range from “Aug. 17, 2016” to “Aug. 26, 2016” as shown in FIG. 9, only task messages which processing deadlines fall within the date range between “Aug. 17, 2016” and “Aug. 26, 2016” may be displayed.

S210: The electronic device sends task reminding request(s) to the server for the task message(s), to cause the server to perform task reminding event(s) accordingly.

S212: The electronic device responds to the task reminding event(s).

In implementations, a processing deadline of each task message may also be obtained, and a task reminding request corresponding to each task message is initiated to the server according to the processing deadline. Responsive to a task reminding event initiated by the server at a corresponding reminding time point before the processing deadline, a task reminding operation is thereby implemented for the user.

In one case, the DING Talk client can perform the above task reminding operation for all the obtained task messages by default without requiring the user to perform separate processing. In another case, since the user may have a large number of task messages, the user may be disturbed and affected if task reminding operations are performed for them all. Therefore, task messages requiring reminders may be manually configured by the user. For example, the user may employ a manner as shown in FIG. 3 to set reminders for all task messages corresponding to a certain type of processing functions. Alternatively, the user may perform configuration for specific task message(s).

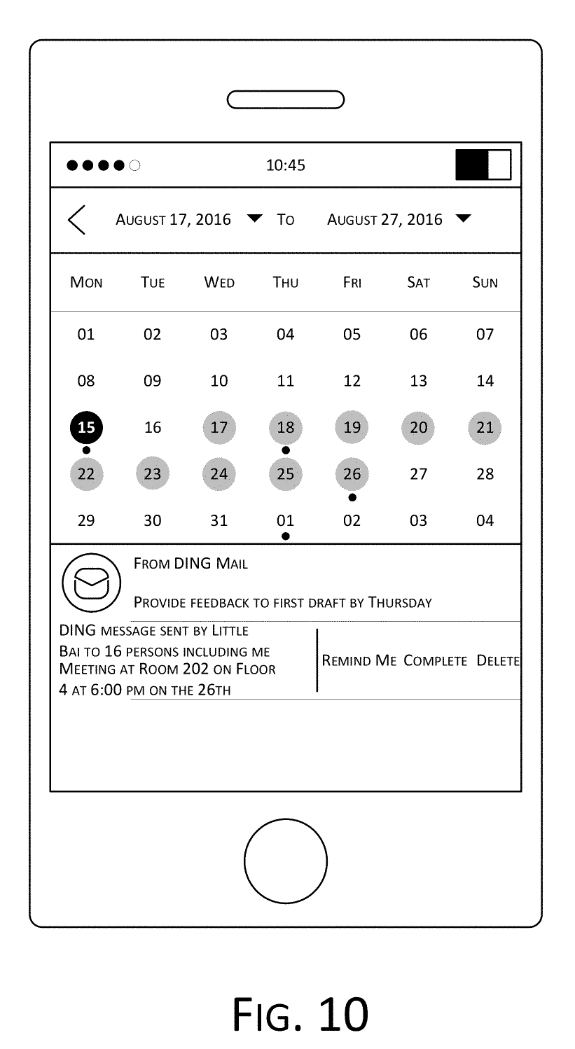

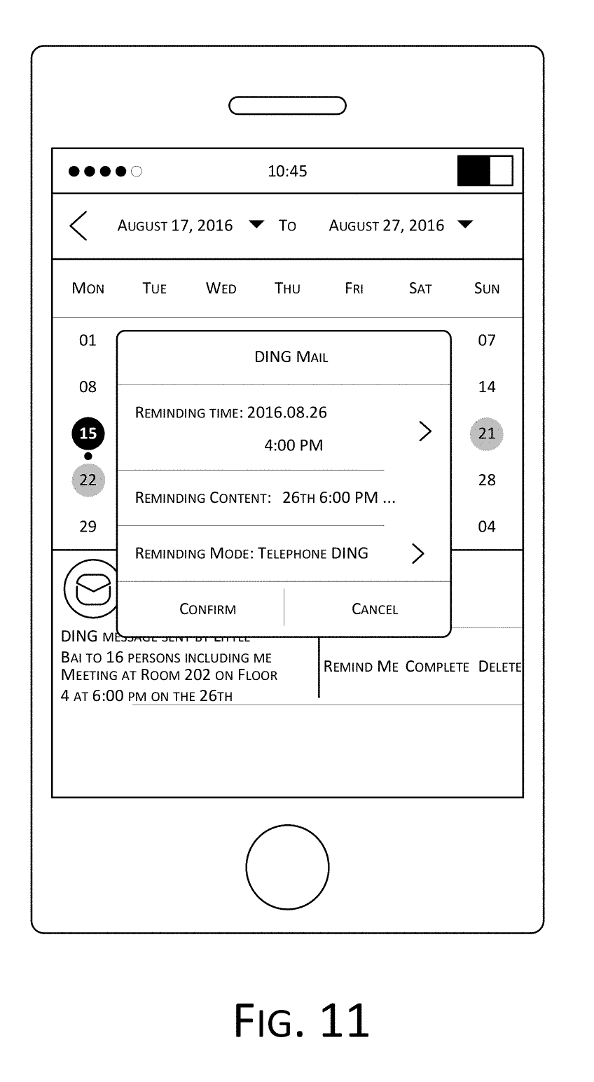

Setting a reminder configuration for a task message by a user is used as an example. As shown in FIG. 9, the user can perform a preset sliding gesture on a task message that is desired to be configured for performing a task reminding operation, for example, sliding to the left, and an operation menu as shown in FIG. 10 may be called. The operation menu includes operation options such as “Remind me”, “Complete”, “Delete”, etc. In response to detecting that the operation option of “Remind me” is selected, a “DING Reminder” configuration page as shown in FIG. 11 can be further called, and the user determines a reminding mode for the task message. For example, the “DING reminder” configuration page may include configuration items such as “reminding time”, “reminding content”, “reminding mode”, etc. The “reminding time” may be default to a preset time (such as 10:00 am) of the day before an associated processing deadline (or any other pre-configured duration before the processing deadline). Alternatively, by further combining with an intelligent semantic analysis of task messages, a more accurate and reasonable reminding operation can be implemented. For example, when a processing deadline is accurate to “day”, such as a task message that comes “from DING Mail—feedback for initial draft on Thursday” in FIG. 9, a processing deadline thereof is “Thursday”, i.e., “Aug. 18, 2016”. In this case, a reminding time can be a preset time (e.g., universally set as 10 am) of the previous day of the processing deadline. When a processing deadline is accurate to “hour”, such as a task message of “DING message sent by Little Bai to 16 persons including me—meeting at Room 202 on Floor 4 at 6:00 pm on the 26th” in FIG. 9, a processing deadline thereof is “6 pm on the 26th”, i.e., “6 pm on Aug. 26, 2016”. In this case, a reminding time can be 2 hours (or any other pre-configured duration) before the processing deadline, i.e., “2016.08.26 4:00 pm” as shown in FIG. 11. The “reminding content” can be message content of a corresponding task message by default. The “reminding mode” can be “telephone DING” (i.e., calling the user, and a voice playback of the “reminding content” is made after a connection is established) by default. Apparently, the user can modify and configure each of the above configuration items according to actual needs, and details thereof are not described herein again.

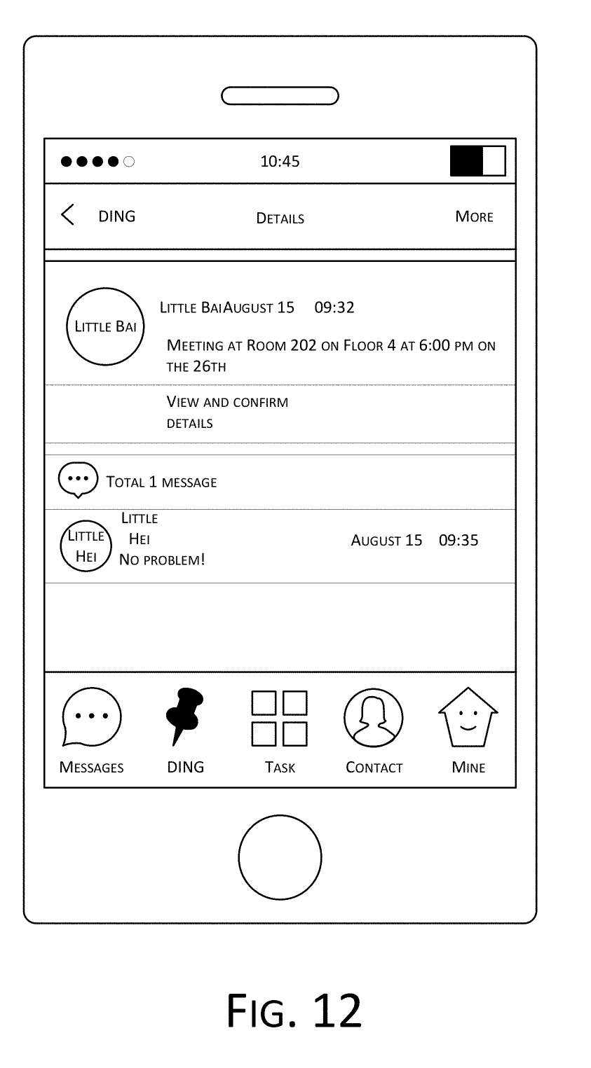

In implementations, according to a triggering operation that is received for any task message, switching to a processing page of that task message can be performed. For example, the user triggers the task message of “DING message sent by Little Bai to 16 persons including me—meeting at Room 202 on Floor 4 at 6:00 pm on the 26th” in FIG. 9 (or other pages displaying task messages) by clicking (or other triggering modes), a jump can be made to a detailed browsing page as shown in FIG. 12, to allow the user can to view the details of the task message. In this way, each task message can be regarded as a quick entrance for a processing page of a corresponding processing function. In a page such as the one as shown in FIG. 4 or FIG. 5, by displaying obtained task messages in a centralized manner, entrances for processing pages of related processing functions are also actually displayed in a centralized manner, so that the user does not need to manually find an entrance for each processing function, but can quickly enter a processing page of each processing function from the page as shown in FIG. 4 or FIG. 5, thus helping to enhance the task processing efficiency of the user.

In addition, other than editing task messages that have been generated through “Remind me”, “Complete”, “Delete”, etc. as shown in FIG. 10, a task message can be manually added according to the needs of the user. For example, an “Add” button may be set in the upper right corner of the pages as shown in FIGS. 4-6, so that a corresponding manual configuration page may be provided to the user for manually creating and adding task messages to meet the personalized needs of the user, in response to detecting a triggering operation of the user on the “Add” button.

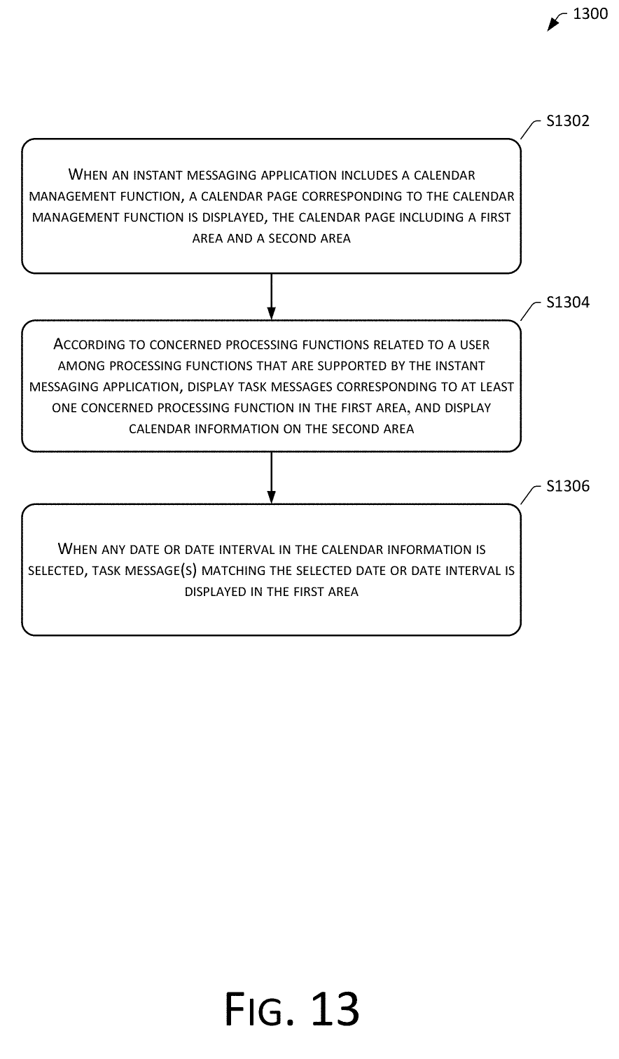

For the embodiments as shown in FIG. 4 and FIGS. 7-11, etc., that is, the processing schemes of simultaneously displaying task messages and calendar information in a first area and a second area of a calendar page, FIG. 13 shows a flowchart of a corresponding task reminding method 1300 for a plurality of information sources. The method 1300 may include the following operations.

S1302: When an instant messaging application includes a calendar management function, a calendar page corresponding to the calendar management function is displayed, the calendar page including a first area and a second area.

S1304: According to concerned processing functions related to a user among processing functions that are supported by the instant messaging application, display task messages corresponding to at least one concerned processing function in the first area, and display calendar information on the second area.

S1306: When any date or date interval in the calendar information is selected, task message(s) matching the selected date or date interval is displayed in the first area.

In implementations, by displaying the calendar information and the task messages on a same page, the user can implement a rapid management of the task messages by combining the calendar information with the task messages. Furthermore, by selecting a date or date interval in the calendar information and displaying corresponding task message(s) in the first area, the user can quickly screen and manage the task messages through the calendar information, which helps to improve the efficiency of processing the task messages by the user.

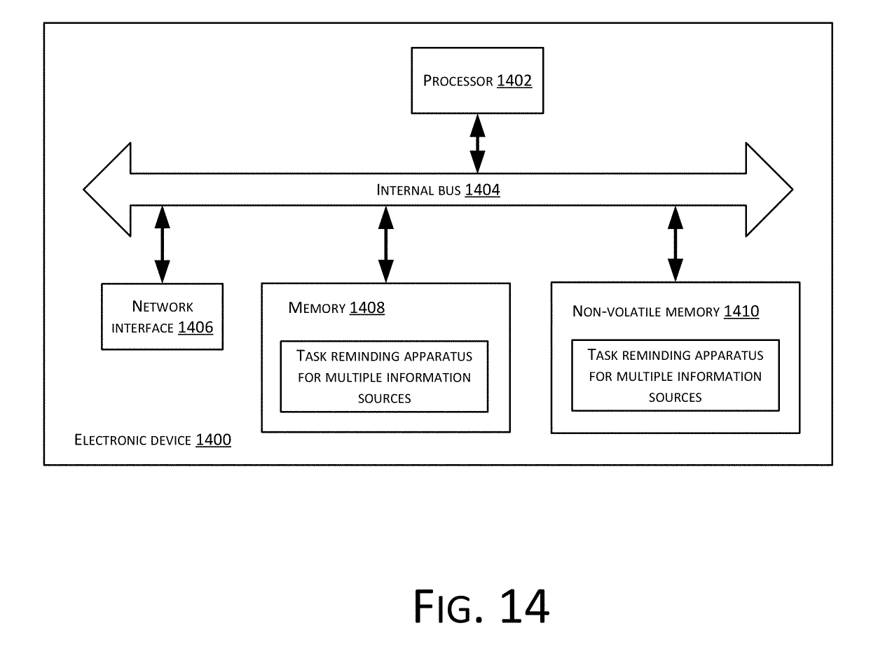

FIG. 14 shows a schematic structural diagram of an electronic device 1400 according to an exemplary embodiment of the present disclosure. Referring to FIG. 14, at the hardware level, the electronic device 1400 includes a processor 1402, an internal bus 1404, a network interface 1406, memory 1408, and non-volatile memory 1410. Apparently, hardware needed by other services may also be included. The processor 1402 reads a corresponding computer program from the non-volatile memory 1410 into the memory 1402 and then runs to form a task reminding apparatus for multiple information sources at the logical level. Apparently, in addition to software implementations, the present disclosure does not exclude other manners of implementation, such as a logic device or a combination of software and hardware, etc. In other words, an execution entity of the following handling process is not limited to each logical unit, and may be hardware or a logic device.

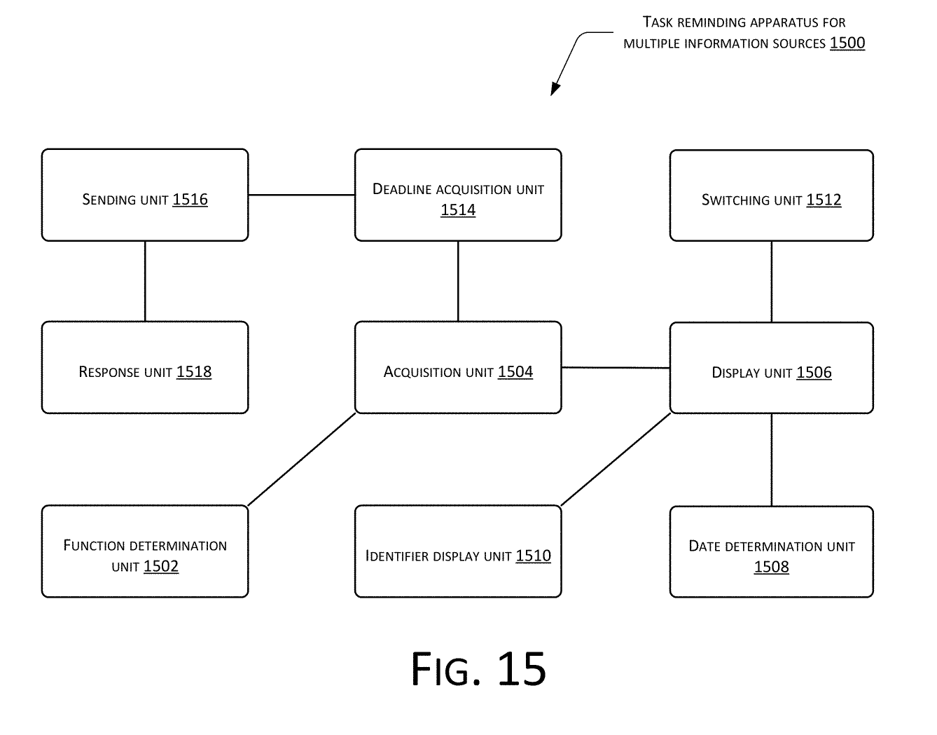

Referring to FIG. 15, a task reminding apparatus 1500 for multiple information sources may include a function determination unit 1502, an acquisition unit 1504, and a display unit 1506.

The function determination unit 1502 determines concerned processing function(s) related to a user from among processing functions that are supported by an instant messaging application.

The acquisition unit 1504 obtains task message(s) corresponding to the at least one concerned processing function.

The display unit 1506 displays the obtained task message(s) in a centralized manner.

Optionally, the display unit 1506 is specifically configured to display the obtained task message(s) in a first area of a calendar page corresponding to a calendar management function in the centralized manner when the instant messaging application includes the calendar management function, wherein calendar information is displayed in a second area of the calendar page that is different from the first area.

Optionally, the display unit 1506 is specifically configured to select a task message matching the calendar information from among the obtained task message(s) for display in the first area.

Optionally, the apparatus 1500 may further include a date determination unit 1508 which determines a selected date or date interval in the calendar information according to a user selection instruction that is received.

The display unit 1506 is specifically configured to display a task message matching the selected date or date interval in the first area.

Optionally, the apparatus 1500 may further include an identifier display unit 1510 which displays a preset prompt identifier on any date when a matching task message exists on the any date of the calendar information.

Optionally, the apparatus 1500 may further include a switching unit 1512 which switches to a processing page of any task message according to a triggering operation received for the any task message.

Optionally, the apparatus 1500 may further include a deadline acquisition unit 1514 that obtains a processing deadline of each task message; a sending unit 1516 that initiates a task reminding request corresponding to each task message to a server according to the processing deadline; and a response unit 1518 that responds to a task reminding event initiated by the server at a corresponding reminding time point before the processing deadline.

Optionally, at least one processing function of the processing functions that are supported by the instant messaging application is pre-configured by the user as a concerned processing function.

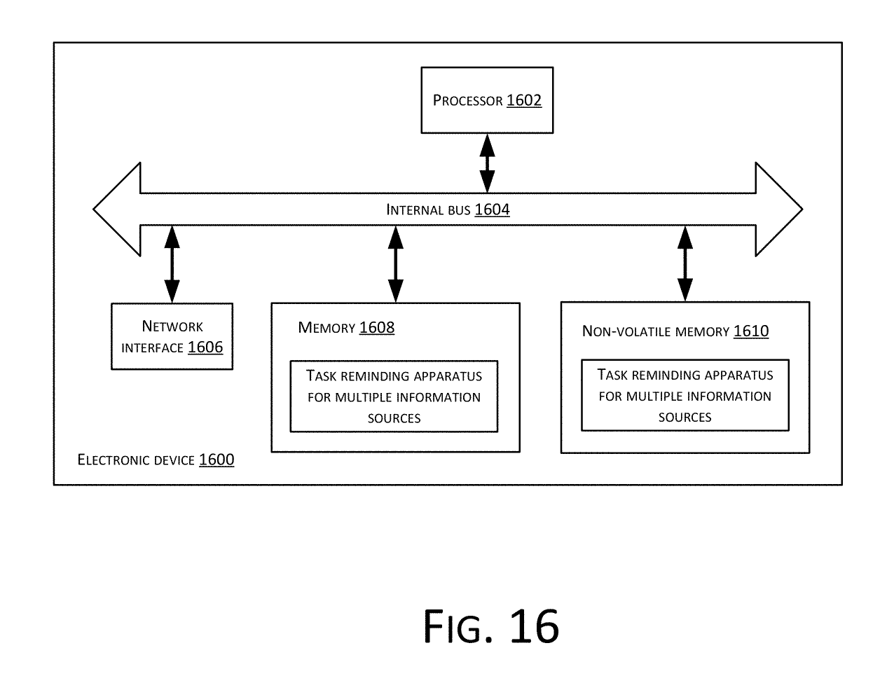

FIG. 16 shows a schematic structural diagram of an electronic device 1600 according to an exemplary embodiment of the present disclosure. Referring to FIG. 16, at the hardware level, the electronic device 1600 includes a processor 1602, an internal bus 1604, a network interface 1606, memory 1608, and non-volatile memory 1610. Apparently, hardware needed by other services may also be included. The processor 1602 reads a corresponding computer program from the non-volatile memory 1610 into the memory 1602 and then runs to form a task reminding apparatus for multiple information sources at the logical level. Apparently, in addition to software implementations, the present disclosure does not exclude other manners of implementation, such as a logic device or a combination of software and hardware, etc. In other words, an execution entity of the following handling process is not limited to each logical unit, and may be hardware or logic device.

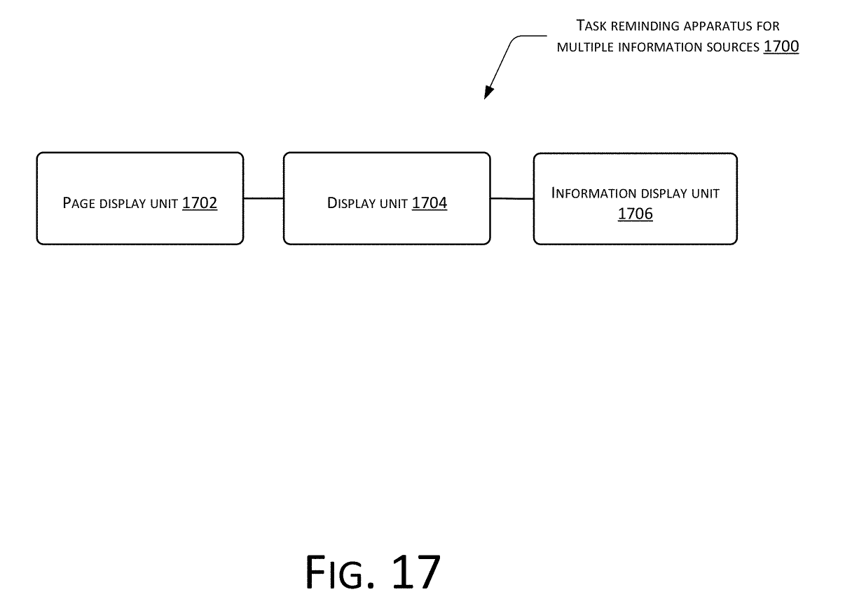

Referring to FIG. 17, a task reminding apparatus 1700 for multiple information sources may include a page display unit 1702, a display unit 1704, and a message display unit 1706.

The page display unit 1702 displays a calendar page corresponding to a calendar management function when an instant messaging application includes the calendar management function, the calendar page including a first area and a second area.

The display unit 1704 displays task message(s) corresponding to at least one concerned processing function in the first area according to concerned processing function(s) related to a user among processing functions that are supported by the instant messaging application, and displays calendar information in the second area.

The message presentation unit 1706 displays, when any date or date interval in the calendar information is selected, a task message matching the selected date or date interval in the first area.

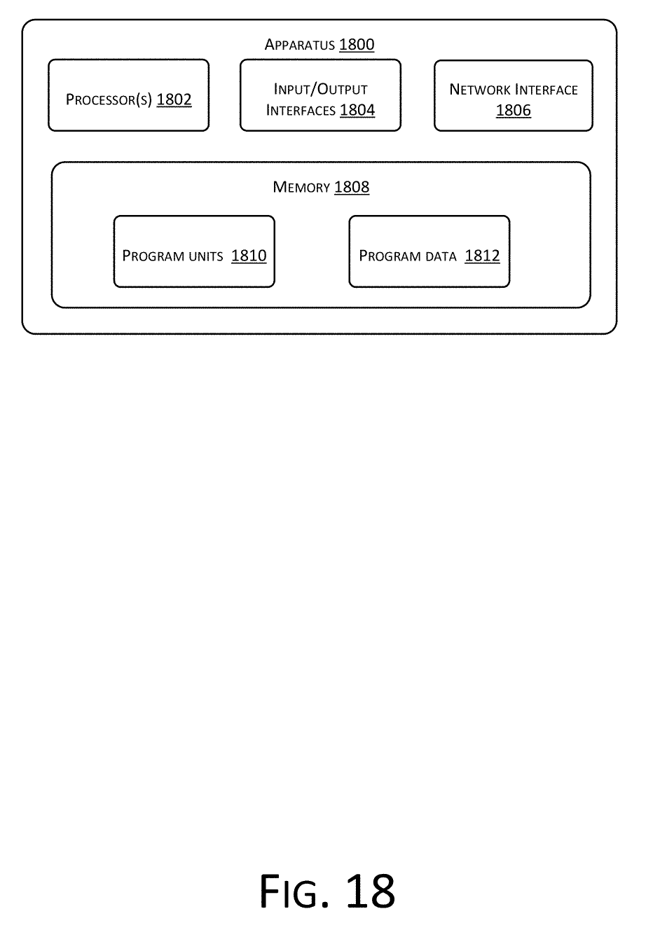

FIG. 18 shows a schematic structural diagram of an example apparatus 1800 such as the apparatuses 1500 and 1700 in further detail. In implementations, the apparatus 1800 may include one or more computing devices. In implementations, the apparatus 1800 may be a part of one or more computing devices, e.g., implemented or run by the one or more computing devices. In implementations, the one or more computing devices may be located in a single place or distributed among a plurality of network devices over a network. In a typical configuration, a computing device includes one or more processors (CPU), an input/output interface, a network interface, and memory. By way of example and not limitation, the apparatus 1800 may include one or more processors 1802, an input/output (I/O) interface 1804, a network interface 1806, and memory 1808.

The memory 1808 may include a form of computer readable media such as a volatile memory, a random access memory (RAM) and/or a non-volatile memory, for example, a read-only memory (ROM) or a flash RAM. The memory 1808 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 1808 may include program units 1810 and program data 1812. The program units 1810 may include one or more of the foregoing units as described in the foregoing description and FIGS. 15 and 17.

It is also noted that terms “include”, “contain” or any other variations are intended to encompass a non-exclusive inclusion, such that a process, method, product, or device that includes a series of elements not only includes these elements, but also includes other elements that are not explicitly listed, or also includes elements that are inherent to such process, method, product, or device. Without further limitation, an element that is defined by a phrase “comprising a . . . ” does not exclude the presence of other identical elements in a process, method, product, or device that includes the element.

Exemplary embodiments are described in detail herein, and examples thereof are illustrated in the accompanying drawings. When the accompanying drawings are involved in the following description, same or similar numbers in different figures represent same or similar elements, unless indicated otherwise. Implementations described in the following exemplary embodiments do not represent all the embodiments that are consistent with the present disclosure. Instead, they are merely examples of apparatuses and methods that are consistent with some aspects of the present disclosure as detailed in the appended claims.

Terminologies used in the present disclosure are merely for the purpose of describing particular embodiments, and are not intended to limit the present disclosure. Singular forms “a”, “said” and “the” are intended to include plural forms, unless stated clearly in the context otherwise. It should also be understood that a term “and/or” used herein refers to and includes any or all possible combinations of one or more of associated items that are listed.

It should be understood that, although terms such as first, second, third, etc. may be used in the present disclosure to describe various types of information, these pieces of information should not be limited to these terms. These terms are merely used for distinguishing information of the same type. For example, without departing from the scope of the present disclosure, first information may also be referred to as second information, and similarly, the second information may also be referred to as the first information. Depending on the context, a term “if” used herein may be interpreted as “when” or “in an event of” or “in response to determining”.

The above description corresponds to preferred embodiments of the present disclosure merely, and is not intended to limit the present disclosure. Any modifications, equivalent replacements, improvements, etc. that are made within the spirit and principles of the present disclosure are included in the scope of protection of the present disclosure.

The present application can be further understood using the following clauses.

Clause 1: A task reminding method for multiple information sources, comprising: determining concerned processing functions related to a user from among processing functions that are supported by an instant messaging application; obtaining task messages corresponding to the at least one concerned processing function; and displaying the obtained task messages in a centralized manner.

Clause 2: The method of Clause 1, wherein displaying the obtained task messages in the centralized manner comprises displaying the obtained task messages in a first area of a calendar page corresponding to a calendar management function in the centralized manner when the instant messaging application includes the calendar management function, wherein calendar information is displayed in a second area of the calendar page that is different from the first area.

Clause 3: The method of Clause 2, wherein displaying the obtained task messages in the centralized manner comprises selecting a task message matching the calendar information from the obtained task messages for display in the first area.

Clause 4: The method of Clause 2, further comprising determining a selected date or date interval in the calendar information according to a user selection instruction that is received, wherein displaying the obtained task messages in the centralized manner comprises displaying a task message matching the selected date or date interval in the first area.

Clause 5: The method of Clause 2, further comprising displaying a preset prompt identifier in any one date when a matching task message exists in the any one date in the calendar information.

Clause 6: The method of Clause 1, further comprising switching to a processing page of any one task message according to a triggering operation received for the any one task message.

Clause 7: The method of Clause 1, further comprising: obtaining a processing deadline for each task message; sending a task reminding request for each task message to a server according to the processing deadline; and responding to a task reminding event initiated by the server at a corresponding reminding time point before the processing deadline.

Clause 8: The method of Clause 1, wherein at least one processing function in the processing functions supported by the instant messaging application is pre-configured by the user as the concerned processing functions.

Clause 9: A task reminding method for multiple information sources, comprising: displaying a calendar page corresponding to a calendar management function when an instant messaging application includes the calendar management function, the calendar page including a first area and a second area; displaying task messages corresponding to at least one concerned processing function in the first area according to concerned processing functions related to a user among processing functions that are supported by the instant messaging application; displaying calendar information in the second area; and when any date or date interval in the calendar information is selected, displaying a task message matching the selected date or date interval in the first area.

Clause 10: A task reminding apparatus for multiple information sources, comprising: a function determination unit that determines concerned processing functions related to a user from among processing functions that are supported by an instant messaging application; an acquisition unit that obtains task messages corresponding to the at least one concerned processing function; and a display unit that displays the obtained task messages in a centralized manner.

Clause 11: The apparatus of Clause 10, wherein the display unit is specifically configured to display the obtained task messages in a first area of a calendar page corresponding to a calendar management function in the centralized manner when the instant messaging application includes the calendar management function, wherein calendar information is displayed in a second area of the calendar page that is different from the first area.

Clause 12: The apparatus of Clause 11, wherein the display unit is specifically configured to select a task message matching the calendar information from the obtained task messages for display in the first area.

Clause 13: The apparatus of Clause 11, further comprising a date determination unit that determines a selected date or date interval in the calendar information according to a user selection instruction that is received, wherein the display unit is specifically configured to display a task message matching the selected date or date interval in the first area.

Clause 14: The apparatus of Clause 11, further comprising an identifier display unit that displays a preset prompt identifier in any one date when a matching task message exists in the any one date in the calendar information.

Clause 15: The apparatus of Clause 10, further comprising a switching unit that performs a switching to a processing page of any one task message according to a triggering operation received for the any one task message.

Clause 16: The apparatus of Clause 10, further comprising: a deadline acquisition unit that obtains a processing deadline for each task message; a sending unit that sends a task reminding request for each task message to a server according to the processing deadline; and a response unit that responds to a task reminding event initiated by the server at a corresponding reminding time point before the processing deadline.

Clause 17: The apparatus of Clause 10, wherein at least one processing function in the processing functions supported by the instant messaging application is pre-configured by the user as the concerned processing functions.

Clause 18: A task reminding apparatus for multiple information sources, comprising: a page display unit that displays a calendar page corresponding to a calendar management function when an instant messaging application includes the calendar management function, the calendar page including a first area and a second area; a display unit that displays task messages corresponding to at least one concerned processing function in the first area according to concerned processing functions related to a user among processing functions that are supported by the instant messaging application, displaying calendar information in the second area; and an information display unit that displays, when any date or date interval in the calendar information is selected, a task message matching the selected date or date interval in the first area.

What is claimed is:

1. A method implemented by one or more computing devices, the method comprising:
determining concerned processing functions related to a user from among processing functions that are supported by an instant messaging application;
obtaining task messages corresponding to the at least one concerned processing function; and
displaying the obtained task messages in a centralized manner.

2. The method of claim 1, wherein displaying the obtained task messages in the centralized manner comprises displaying the obtained task messages in a first area of a calendar page corresponding to a calendar management function in the centralized manner when the instant messaging application includes the calendar management function.

3. The method of claim 2, wherein calendar information is displayed in a second area of the calendar page that is different from the first area.

4. The method of claim 2, wherein displaying the obtained task messages in the centralized manner comprises selecting a task message matching the calendar information from the obtained task messages for display in the first area.

5. The method of claim 2, further comprising determining a selected date or date interval in the calendar information according to a user selection instruction that is received, wherein displaying the obtained task messages in the centralized manner comprises displaying a task message matching the selected date or date interval in the first area.

6. The method of claim 2, further comprising displaying a preset prompt identifier in a date when a matching task message exists in the date in the calendar information.

7. The method of claim 1, further comprising switching to a processing page of a particular task message according to a triggering operation received for the particular task message.

8. The method of claim 1, further comprising:
obtaining a processing deadline for each task message;
sending a task reminding request for each task message to a server according to the processing deadline; and
responding to a task reminding event initiated by the server at a corresponding reminding time point before the processing deadline.

9. The method of claim 1, wherein at least one processing function in the processing functions supported by the instant messaging application is pre-configured by the user as the concerned processing functions.

10. An apparatus comprising:
one or more processors;
memory;
a function determination unit stored in the memory and executable by the one or more processors to determine concerned processing functions related to a user from among processing functions that are supported by an instant messaging application;
an acquisition unit stored in the memory and executable by the one or more processors to obtain task messages corresponding to the at least one concerned processing function; and
a display unit stored in the memory and executable by the one or more processors to display the obtained task messages in a centralized manner.

11. The apparatus of claim 10, wherein the display unit is further configured to display the obtained task messages in a first area of a calendar page corresponding to a calendar management function in the centralized manner when the instant messaging application includes the calendar management function

12. The apparatus of claim 11, wherein calendar information is displayed in a second area of the calendar page that is different from the first area.

13. The apparatus of claim 11, wherein the display unit is further configured to select a task message matching the calendar information from the obtained task messages for display in the first area.

14. The apparatus of claim 11, further comprising a date determination unit in the memory and executable by the one or more processors to determine a selected date or date interval in the calendar information according to a user selection instruction that is received, wherein the display unit is specifically configured to display a task message matching the selected date or date interval in the first area.

15. The apparatus of claim 11, further comprising an identifier display unit in the memory and executable by the one or more processors to display a preset prompt identifier in a date when a matching task message exists in the date in the calendar information.

16. The apparatus of claim 10, further comprising a switching unit in the memory and executable by the one or more processors to perform a switching to a processing page of a particular task message according to a triggering operation received for the particular task message.

17. The apparatus of claim 10, further comprising:
a deadline acquisition unit in the memory and executable by the one or more processors to obtain a processing deadline for each task message;
a sending unit in the memory and executable by the one or more processors to send a task reminding request for each task message to a server according to the processing deadline; and
a response unit in the memory and executable by the one or more processors to respond to a task reminding event initiated by the server at a corresponding reminding time point before the processing deadline.

18. The apparatus of claim 10, wherein at least one processing function in the processing functions supported by the instant messaging application is pre-configured by the user as the concerned processing functions.

19. One or more computer readable media storing executable instructions that, when executed by one or more processors, cause the one or more processors to perform acts comprising:
displaying a calendar page corresponding to a calendar management function when an instant messaging application includes the calendar management function, the calendar page including a first area and a second area;
displaying task messages corresponding to at least one concerned processing function in the first area according to concerned processing functions related to a user among processing functions that are supported by the instant messaging application, displaying calendar information in the second area; and
in response to a date or date interval in the calendar information being selected, displaying a task message matching the selected date or date interval in the first area.

20. The one or more computer readable media of claim 19, wherein calendar information is displayed in the second area, the second area being different from the first area.
